(19) United States
(12) Patent Application Publication
(10) Pub. No.: US 2013/0281132 A1
(43) Pub. Date: Oct. 24, 2013

(54) AUTOMATED PHYSICAL LOCATION IDENTIFICATION OF MANAGED ASSETS

(71) Applicant: Christopher A. Poblete, Austin, TX (US)

(72) Inventor: Christopher A. Poblete, Austin, TX (US)

(73) Assignee: Dell Products L.P., Round Rock, TX (US)

(21) Appl. No.: 13/454,854

(22) Filed: Apr. 24, 2012

(51) Int. Cl. H04W 4/02

(52) U.S. Cl. 455/457

(57) ABSTRACT

A managed asset physical location identification system includes a network. A managed asset is coupled to the network. The managed asset is operable, in response to detecting an event in the managed asset, to send an event notification that is associated with the event over the network. A locator system is coupled to the network. The located system is operable to receive the event notification, determine a physical location of the managed asset using the event notification, and display the event notification and the physical location of the managed asset.

### BACKGROUND

The present disclosure relates generally to information handling systems, and more particularly to the automated physical location identification of information handling systems.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Some IHS's have the capability to perform self-management services such as event monitoring and notification. An IHS may monitor several components in the IHS to determine if an event such as, for example, a component failure, occurs and, in response, the IHS will send a notification of the component failure to a management IHS. For example, in the event that a fan in the IHS fails, the IHS will send a notification to the management IHS that the fan has failed. The notification typically includes an IP address or IHS name to identify the IHS that sent the notification. The notification us then displayed on the management IHS such that a user of the management IHS is informed of the failure of the component in the IHS.

However, in large data centers or other networked IHS systems, the user of the management IHS is then tasked with determining the physical location of the IHS that sent the notification in order to address the failure of the component in the IHS. Conventionally, the user of management IHS will manually compile a list of IHS physical locations such that, when an event notification from a particular IHS is received, the user may then look up the physical location of that particular IHS in the list. Such lists are time consuming to create and update, and failures to update the list as the physical locations of IHSs change (or IHSs are added to the networked IHS system) provides stale IHS location data that results in the user of the management system not being able to determine the physical location of an IHS when that IHS sends an event notification. Failure to determine the physical locations of IHS's in response to event notifications results in costly IHS downtimes in which the IHS is not operating or operating improperly while the user of the management IHS attempts to determine the physical location of the IHS.

Accordingly, it would be desirable to provide an improved IHS physical location identification system.

### SUMMARY

According to one embodiment, a managed asset physical location identification system includes a network; a managed asset that is coupled to the network and that is operable, in response to detecting an event in the managed asset, to send an event notification that is associated with the event over the network; and a locator system that is coupled to the network and that is operable to: receive the event notification; determine a physical location of the managed asset using the event notification; and display the event notification and the physical location of the managed asset.

### BRIEF DESCRIPTION OF THE DRAWINGS

FIG. 1 is a schematic view illustrating an embodiment of an information handling system.

FIG. 2 is a schematic view illustrating an embodiment of a networked system.

FIG. 3 is a schematic view illustrating an embodiment of a managed asset physical location identification system.

FIG. 4 is a schematic view illustrating an embodiment of a managed asset physical location identification system.

FIG. 5 is a schematic view illustrating an embodiment of a managed asset physical location identification system.

FIG. 6 is a flow chart illustrating an embodiment of a method for storing a physical location of a managed asset.

FIG. 7 is a flow chart illustrating an embodiment of a method for providing the physical location of a managed asset.

FIG. 8 is a front view illustrating an embodiment of a locator device displaying an event notification screen including an indication of the physical location of a managed asset in which the event was detected.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a display device or monitor, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

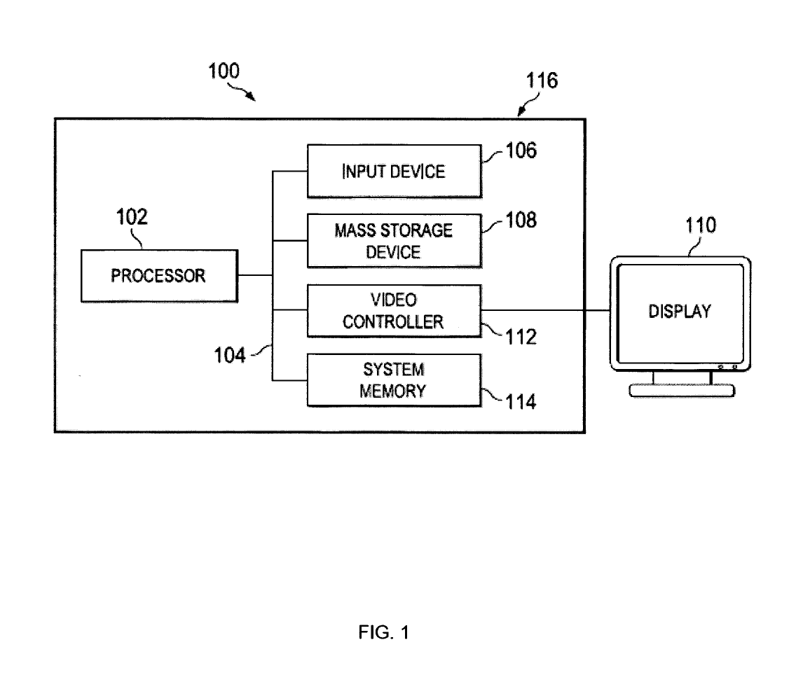

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

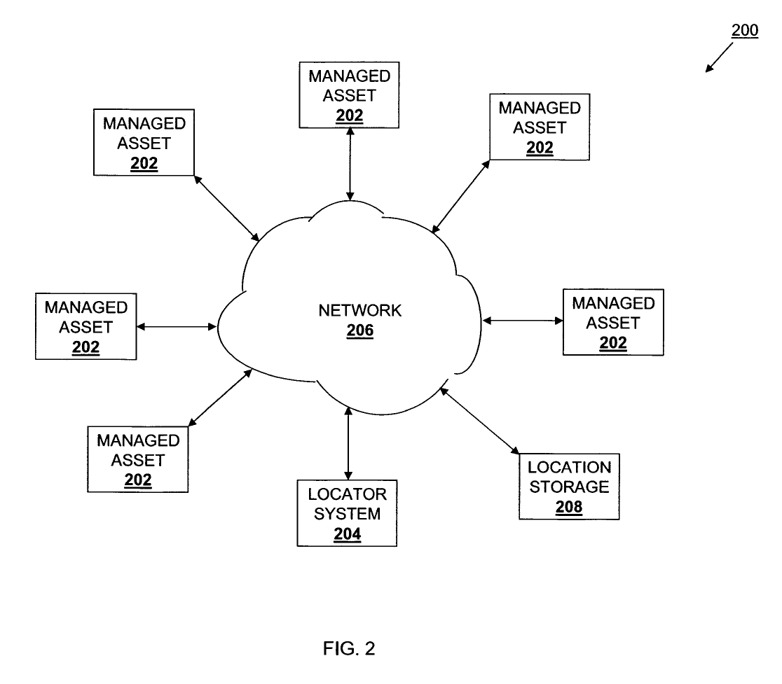

Referring now to FIG. 2, a networked system 200 is illustrated. The networked system 200 includes a plurality of managed assets 202 coupled to a locator system 204 over a network 206. In some embodiments, a location storage 208 may be coupled to the locator system 204 over the network 206, as discussed in further detail below. In an embodiment, the network 206 includes a Transport Control Protocol/Internet Protocol (TCP/IP) network (e.g., the Internet or an intranet). In an embodiment, any or all of the managed assets 202, the locator system 204, and the location storage 208 may be an IHS such as, for example, the IHS 100 described above with reference to FIG. 1. In some embodiments, the managed assets 202 may include IHS's or IHS components such as, for example, server IHS's, desktop IHS's, notebook IHS's, tablet IHS's, phone IHS's, printers, speakers, processors, fans, and/or a variety of other IHS or IHS components known in the art. In an embodiment, each of the managed assets 202 is operable to perform self-management services such as, for example, event monitoring, event notification, and/or a variety of other self-management services known in the art. In some embodiments, the locator system 204 may include IHS's such as, for example, management IHS's, server IHS's, desktop IHS's, notebook IHS's, tablet IHS's, phone IHS's and/or a variety of other IHS's known in the art. In some embodiments, the location storage 208 may include storage mediums such as server IHS's, storage IHS's, storage devices, remote access controller IHS's, management IHS's, and/or a variety of other storage mediums known in the art. In one example, the networked system 200 includes many managed assets 202 that are located at different physical locations (e.g., within a room, within a plurality of rooms in a building, within rooms in a plurality of buildings, etc.) and the locator system 204 includes one or more mobile/portable locator devices (e.g., notebook IHS's, tablet IHS's, phone IHS's, etc.) operated by users that help to manage the networked system 200. While a specific embodiment of the networked system is illustrated and described herein, one of skill in the art will recognize that a variety of modification to the network system 200 will fall within the scope of the present disclosure.

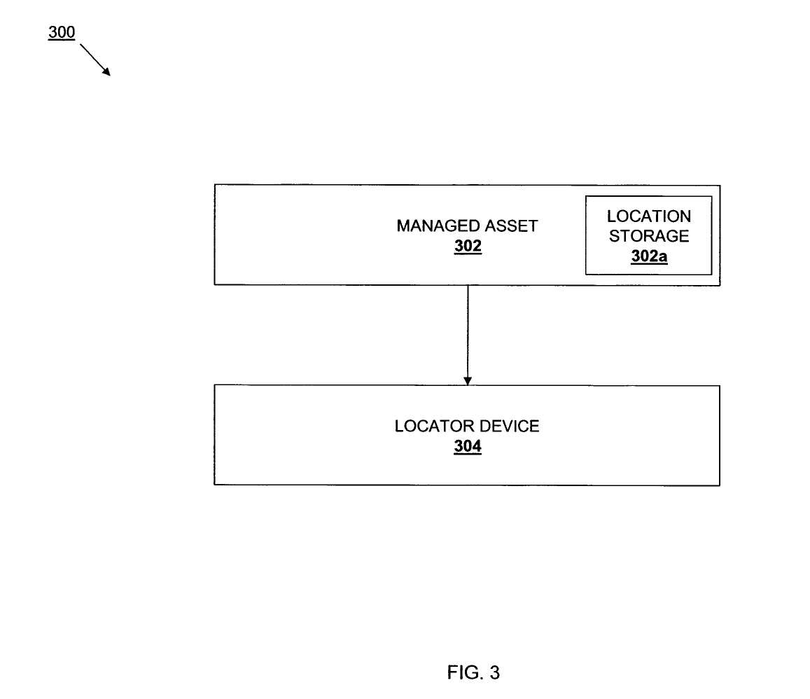

Referring now to FIG. 3, an embodiment of a managed asset physical location identification system 300 is illustrated. The managed asset physical location identification system 300 includes a managed asset 302 that includes and/or is coupled to a location storage 302a. The managed asset 302 is also coupled to a locator device 304. In an embodiment, the managed asset 302 may be any of the managed assets 202 discussed above with reference to FIG. 2, the locator device 304 may be part of the locator system 204 discussed above with reference to FIG. 2, and the managed asset 302 may be coupled to the locator device 304 through the network 206 discussed above with reference to FIG. 2. For example, the managed asset 302 may be a server IHS that includes the location storage 302a (e.g., as a storage device in the server IHS) and that is coupled through the network 206 to the locator device 304 that includes a mobile/portable IHS. In another example, the managed asset 302 may be an IHS component (e.g., a processor) in an IHS (e.g., a server IHS) that is coupled to the location storage 302a in the IHS.

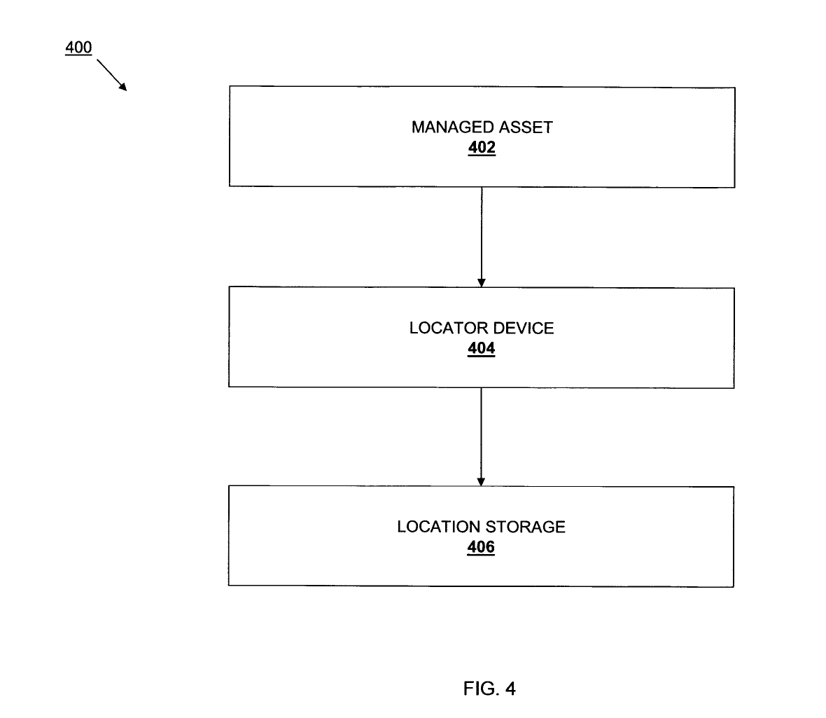

Referring now to FIG. 4, an embodiment of a managed asset physical location identification system 400 is illustrated. The managed asset physical location identification system 400 includes a managed asset 402 that is coupled to a locator device 404. The locator device 404 is coupled to a location storage 406. In an embodiment, the managed asset 402 may be any of the managed assets 202 discussed above with reference to FIG. 2, the locator device 404 may be part of the locator system 204 discussed above with reference to FIG. 2, the location storage 406 may be the location storage 208 discussed above with reference to FIG. 2, and the managed asset 402, the locator device 404, and the location storage 406 may be coupled together through the network 206 discussed above with reference to FIG. 2. For example, the managed asset 402 may be a server IHS that is coupled through the network 206 to the locator device 304 that includes a mobile/portable IHS, and the locator device 304 is coupled through the network 206 to the location storage 406. In another example, the managed asset 402 may be an IHS component (e.g., a fan) in an IHS (e.g., a server IHS) that is coupled to the locator device 404 through the network 206. In some embodiments, the location storage 406 may be part of a management IHS such as, for example, a management console known in the art that includes management software for managing servers. In some embodiments, the location storage may be part of a Remote Access Controller (RAC) IHS such as, for example, an iDRAC provided by Dell Computers, Inc. of Round Rock, Tex.

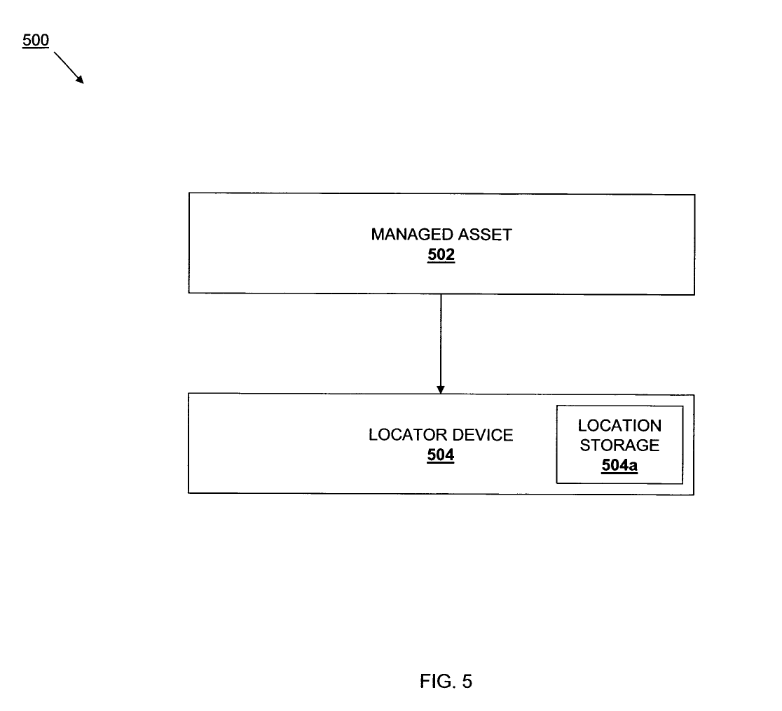

Referring now to FIG. 5, an embodiment of a managed asset physical location identification system 500 is illustrated. The managed asset physical location identification system 500 includes a managed asset 502 that is coupled to a locator device 504 that includes a location storage 504a. In an embodiment, the managed asset 502 may be any of the managed assets 202 discussed above with reference to FIG. 2, the locator device 504 may be part of the locator system 204 discussed above with reference to FIG. 2, and the managed asset 502 may be coupled to the locator device 504 through the network 206 discussed above with reference to FIG. 2. For example, the managed asset 502 may be a server IHS that is coupled through the network 206 to the locator device 504 that includes a mobile/portable IHS that houses the location storage 504a (e.g., a storage device in the mobile/portable IHS). In another example, the managed asset 502 may be an IHS component (e.g., a fan, a processor, etc.) in an IHS (e.g., a server IHS) that is coupled to the locator device 504 through the network 206.

In an embodiment any or all of the managed asset physical location identification systems 300, 400, and/or 500 may be used in the network system 200, discussed above, and operated according to the methods described below.

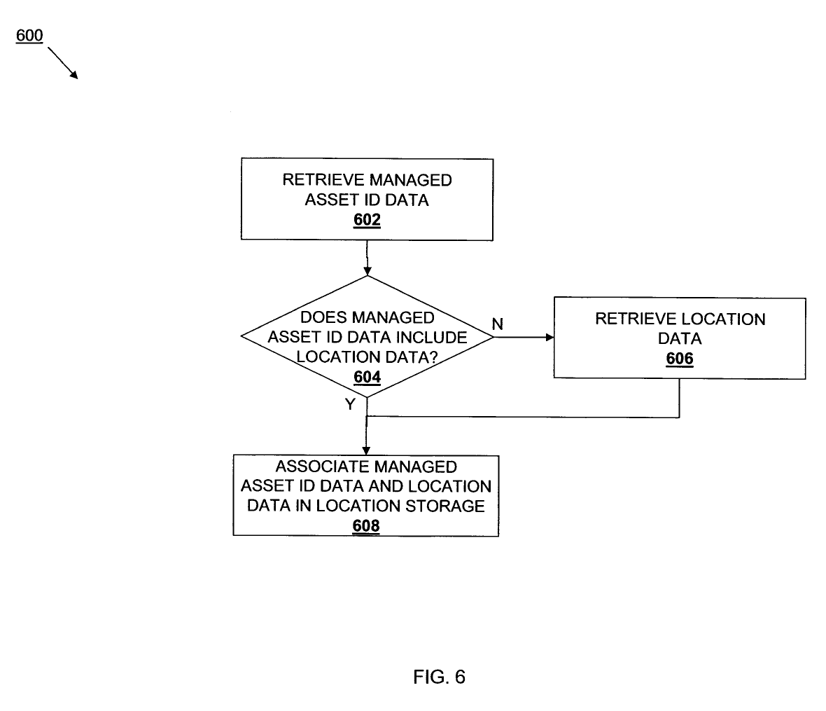

Referring now to FIG. 6, an embodiment of a method 600 for storing a physical location of a managed asset is illustrated. The method 600 may be used to store a physical location of any or all of the managed assets 202, 302, 402, and/or 502, discussed above. The method 600 begins at block 602 where managed asset identification data is retrieved. In an embodiment, each of the managed assets (e.g., the managed assets 202, 302, 402, and 502) includes unique managed asset identification data. In an embodiment, unique managed asset identification data for a managed asset may include metadata. For example, unique managed asset identification data may include a Media Access Control (MAC) address, an IHS service tag, an IHS or IHS component serial number, a universal product code (UPC), a Quick Response (QR) code, and/or a variety of other unique identifiers for an IHS or IHS component known in the art. In an embodiment, unique managed asset identification data may be electronically stored in an IHS (e.g., in the storage device 108 or the system memory 114 described above with reference to FIG. 1, and/or in some other non-volatile storage media known in the art.) In some embodiments, the unique managed asset identification data may be physically affixed to the IHS and/or IHS components (e.g., etched on the IHS or IHS component, using an attachable medium such as a sticker, and/or by a variety of other methods known in the art) as well as or in place of being electronically stored in the IHS.

At block 602 of the method 600, a locator device (e.g., the locator device 304, 404, or 504) may be used to retrieve the managed asset identification data from a managed asset. In one embodiment, the locator device may actively retrieve the managed asset identification data from electronic storage in the managed asset (e.g., the locator device may transmit a signal to the managed asset that causes the managed asset to transmit its managed asset identification data to the locator device) or retrieve the managed asset identification data through a transmission from the managed asset from the electronic storage (e.g., a user may initiate the transmission of the managed asset identification data from the managed asset to the locator device using an input device on the managed asset that causes the managed asset to transmit the managed asset identification data). Any transmission technology supported in both the managed asset and the locator device may be used to transmit the managed asset identification data between the managed asset and the locator device. For example, transmission technologies that use the network 206, Bluetooth™ transmission technologies, optical transmission technologies (e.g., infrared transmission technologies), near-field transmission technologies, and/or a variety of other transmission technologies may be used such that the locator device retrieves the managed asset identification data. In an embodiment, the locator device may retrieve the managed asset identification data from the managed asset at a location that is remote from the physical location of the managed asset (e.g., over the network), or at the same physical location of the managed asset.

In another embodiment, the locator device may retrieve the managed asset identification data from a medium that is physically affixed to the managed asset. For example, the locator device may include scanning technology that allows the managed asset identification data to be retrieved from a medium that is physically affixed to the managed asset (e.g., the locator device may include a laser scanner and the managed asset identification data may be included in a UPC on a sticker affixed to the managed asset). In another example, the locator device may include optical recognition technology that allows the managed asset identification data to be retrieved from the medium that is physically affixed to the managed asset (e.g., the locator device may include a camera, the managed asset identification data may be included in a character string or QR Code on the medium affixed to the managed asset, and software on the locator device may allow for the recognition of the managed asset identification data in the character string or QR code as relayed to the software in an image taken by the camera). While a few examples have been described, the retrieval of the managed asset identification data from a medium that is physically affixed to the managed asset may be accomplished using a variety of technologies known in the art as long as the locator device supports that technology and the managed asset includes the physically affixed medium having the managed asset identification data. Thus, in this embodiment, the locator device may retrieve the managed asset identification data from the managed asset at the same physical location of the managed asset. However, in a locator system (e.g., the locator system 204 described above with reference to FIG. 2), multiple locator devices may allow a first locator device at the physical location of the managed asset to retrieve the managed asset identification data from a medium that is physically affixed to the managed asset, and then transmit that managed asset identification data over the network 206 to a second locator device.

The method 600 then proceeds to decision block 604 where the locator device determines whether the managed asset identification data includes managed asset physical location data. In some embodiments, managed assets may be operable to determine their physical location, and the managed asset identification data may include managed asset physical location data that describes the location of the managed asset. For example, the managed asset may include a location determination device (e.g., a Global Positioning System (GPS) device, an assisted GPS device, a cellular triangulation device, a Wi-Fi™ triangulation device, a radio fingerprinting device, and/or a variety of other location determination devices known in the art), and managed asset physical location data from that location determination device may be included in the managed asset identification data retrieved at block 602 of the method 600. In such an example, the managed asset may be operable to update its managed asset physical location data as the physical location of that managed asset changes. In another example, the managed asset may include the managed asset physical location data on a medium that is physically affixed to the managed asset, and that managed asset physical location data may be included in the managed asset identification data retrieved from that physical medium at block 602 of the method 600.

If, at decision block 604, the locator device determines that the managed asset identification data does not include managed asset physical location data, the method 600 proceeds to block 606 where managed asset physical location data is retrieved. In an embodiment, the locator device is a mobile/portable IHS that includes a location determination device (e.g., a Global Positioning System (GPS) device, an assisted GPS device, a cellular triangulation device, a Wi-Fi™ triangulation device, a radio fingerprinting device, and/or a variety of other location determination devices known in the art) that the locator device may use to retrieve data related to a physical location of the locator device. Thus, at block 606 of the method 600, in response to the managed asset identification data not including managed asset physical location data, a locator device that is in the same physical location as the managed asset may be used to determine a physical location of the locator device (which is also the physical location of the managed asset) that may be used as the managed asset physical location data. In an embodiment, the locator device may be used to add information to the managed asset physical location data such as, for example, details about the physical location of the managed asset (e.g., a building number, a room number, a rack number, etc.). In some embodiments, a locator system (e.g., the locator system 204 described above with reference to FIG. 2) including multiple locator devices may allow a first locator device at the physical location of the managed asset to retrieve the managed asset physical location data for the managed asset, and then transmit that managed asset physical location data over the network 206 to a second locator device.

The method 600 then proceeds to block 608 where the managed asset identification data retrieved in block 602 is associated with the managed asset physical location data that was either included in the managed asset identification data or retrieved in block 606. The associated managed asset identification data and managed asset physical location data are then stored in a location storage. In the embodiment illustrated in FIG. 3, at block 608 of the method 600, the locator device 304 associates the managed asset identification data with the managed asset physical location data in the location storage 302a in the managed asset 302. In the embodiment illustrated in FIG. 4, at block 608 of the method 600, the locator device 404 associates the managed asset identification data with the managed asset physical location data in the location storage 406. In the embodiment illustrated in FIG. 5, at block 608 of the method 600, the locator device 504 associates the managed asset identification data with the managed asset physical location data in the location storage 504a in the locator device 504. In an embodiment, the associated managed asset identification data and managed asset physical location data for each managed asset are stored in a non-volatile storage in the location storage. In an embodiment, the managed asset identification data and the managed asset physical location data may be combined at block 608 of the method to provide managed asset information hereinafter referred to as a managed asset geolocation.

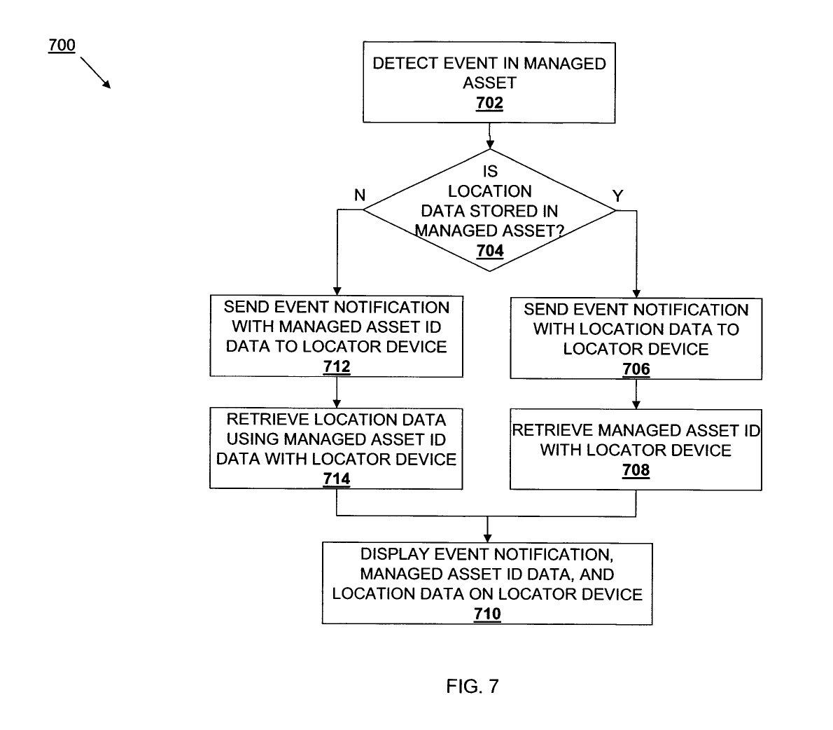

Referring now to FIG. 7, embodiment of a method 700 for providing a physical location of a managed asset is illustrated. The method 700 may be performed to provide a physical location for any of the managed assets 202, 302, 402, and/or 502, discussed above. The method 700 begins at block 700 where an event is detected in a managed asset. As discussed above, each of the managed assets 202 in the networked system 200 is operable to provide self-management services, which may include the detection of events in the managed asset. For example, a system event may occur in a managed asset 202 in the networked system 200. In an embodiment, system events may be categorized as system health events, system configuration events, system audit events, and/or a variety of other system management events known in the art. For example, system\ events may include the failure of an IHS component (e.g., a fan, a processor, etc.) in an IHS, a temperature of an IHS or IHS component exceeding a predetermined level, a root login, a root closing session, a successful license export, a power supply failure, a power supply insertion, a power supply removal, a power supply having an incorrect configuration, a fan RPM within a predetermined range, a redundant fan detection, a processor voltage being outside a predetermined range, the loss of input power, the restoring of input power, the chassis being open while power is on, the system board cable being disconnected, the system board cable being improperly connected, a drive being removed, a drive being installed, a storage cable not being connected, a storage cable being improperly connected, an offline module, the host system is powering off, the host system is performing a reset, a firmware version change on a power supply, and/or a variety of other system events known in the art. At block 702, the managed asset in which the event occurs detects the event using methods known in the art.

The method 700 will then proceed depending on the embodiment of the managed asset physical location identification system that is implemented with regard to the managed asset in which the event was detected in block 702. Thus, while decision block 704 indicates that a determination is made of whether the managed asset physical location data is stored in the managed asset in which the event was detected, in at least some embodiments, that determination may not actually be performed by a component in the managed asset physical location identification system (i.e., in some embodiments, decision block 704 is provided to illustrate how the system may operate differently depending on which embodiment of the managed asset physical location identification system is implemented.)

Referring now to FIGS. 3 and 7, in an embodiment that includes the managed asset physical location identification system 300 implemented in the managed asset in which the event was detected in block 702 of the method 700, managed asset physical location data is stored in the location storage 302a in the managed asset 302. Thus, the method 700 will proceed to block 706 where the managed asset 302 sends an event notification that includes the managed asset physical location data to the locator device 304. In an embodiment, the event notification includes a description of the event detected in block 702, a source IP address or other identifiable information about the source, and/or data that may include any information defined by the source (e.g., service tag information or any other unique system identifier that can be used to map to a physical location, including data about the physical location if that is known or retrievable by the source.) In some embodiments, at block 706 of the method 700, the managed asset 302 sends the managed asset physical location data to the locator device 304 in the event notification. In some embodiments, at block 706 of the method 700, the managed asset 302 sends the managed asset physical location data as part of the managed asset geolocation that is sent to the locator device 304 in the event notification. In some embodiments, at block 706 of the method 700, the managed asset 302 sends the managed asset physical location data and the managed asset identification data to the locator device 304 in the event notification.

The method 700 then proceeds to block 708 where managed asset identification data is retrieved by the locator device. In some embodiments, at block 708 of the method 700, the locator device 304 may use the managed asset physical location data received from the managed asset 302 in the event notification at block 706 to retrieve its associated managed asset identification data (e.g., from a storage device coupled to the locator device 304). In some embodiments, at block 708 of the method 700, the locator device 304 may extract the managed asset identification data from the managed asset geolocation received from the managed asset 302 in the event notification at block 706. In some embodiments, at block 708 of the method 700, the locator device 304 may retrieve the managed asset identification data received from the managed asset 302 in the event notification at block 706.

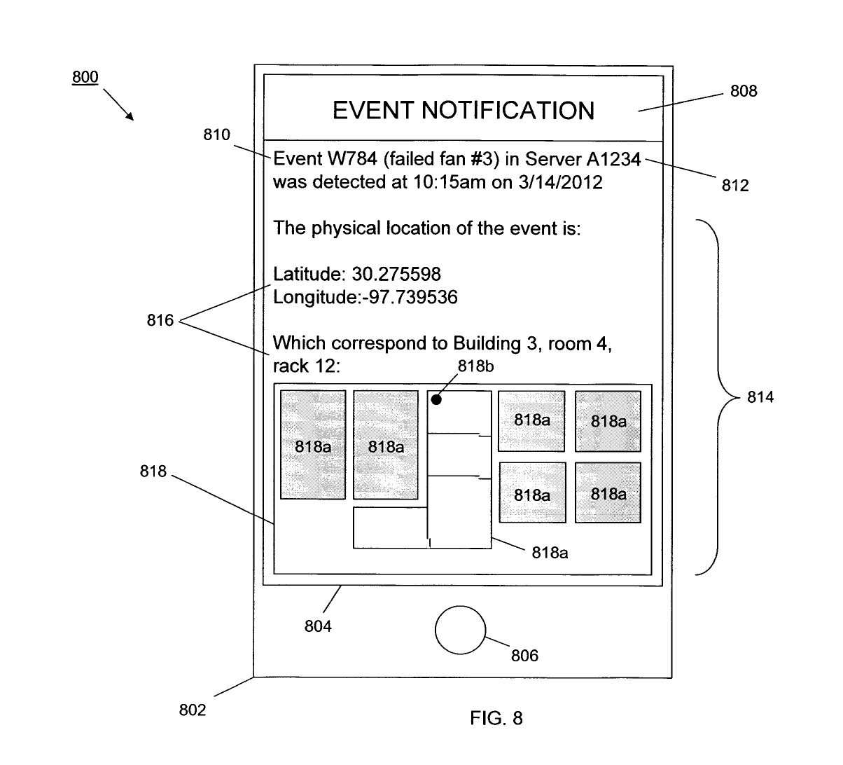

Referring now to FIGS. 7 and 8, the method 700 proceeds to block 710 where the event notification, managed asset identification data, and managed asset physical location data are displayed on the locator device. FIG. 8 includes an embodiment of a locator device 800 which may be, for example, the locator devices 204, 304, 404, and/or 504 discussed above. The locator device 800 includes a chassis 802 having a display 804 and an input button 806. In addition to the input button 806, the display 804 may operate as an input device such as, for example, a touch screen input device known in the art. While the locator device 800 is illustrated and described as a mobile phone-type IHS, one of skill in the art will recognize that a variety of locator device IHSs will fall within the scope of the present disclosure. In an embodiment, the locator device 800 displays on the display 804 an event notification screen 808 that includes an event data 810, managed asset identification data 812, and managed asset physical location data 814. In the illustrated embodiment, the event data 810 includes a textual description of the event (e.g., “Event W784” and/or “(failed fan #3)”). In an embodiment, the textual description of the event in the event data may include the date and time that the event was detected (e.g., “was detected 10:15 am on Mar. 14, 2012”). In an embodiment, the managed asset identification data 812 includes a textual description of the managed asset (e.g., “(failed fan #3) and/or “Server A1234”). In an embodiment, the managed asset physical location data 814 includes textual description 816 (e.g., a latitude and longitude, “Building 3, room 4, rack 12”) and graphical description 818 (e.g., including graphical representations of a plurality of buildings 818a, a plurality of rooms in a building, etc., and a managed asset indicator 818b indicating the location of the managed asset in a room in one of the plurality of buildings 818a).

Referring now to FIGS. 4, 5, and 7, in embodiments that includes the managed asset physical location identification system 400 or 500 implemented in the managed asset in which the event was detected in block 702 of the method 700, managed asset physical location data is stored in the location storage 406 that is coupled to the locator device 404 over a network, or in the location storage 504a located in the locator device 504. Thus, at decision block 704, the method 700 will proceed to block 712 where the managed asset 302 sends an event notification that includes the managed asset identification data to the locator device 404 or 504.

The method 700 then proceeds to block 714 where managed asset physical location data is retrieved by the locator device using the managed asset identification data. The locator devices 404 or 504 may use the managed asset identification data received from the managed asset 402 or 502, respectively, in the event notification at block 712 to retrieve its associated managed asset physical identification data from the location storage 406 or 504a, respectively. The method 700 then proceeds to block 710 where the event notification, managed asset identification data, and managed asset physical location data are displayed on the locator device in substantially the same manner as discussed above with regard to the managed asset physical location identification system 300 and the locator device 800.

Thus, a system and method have been described that provide a user of the managed asset physical location identification system with a notification that an event that has occurred in a managed asset, and along with that notification the user is provided the physical location of that managed asset such that the issue resulting in the event may be quickly and easily addressed. The systems and methods described above allow managed assets to be quickly and easily “geotagged” such that their physical location may be associated with identification data for the managed asset in a database. The systems and methods then utilize this association to provide the physical location of any managed asset in the system to a user of the system in response to the managed asset detecting an event.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A managed asset physical location identification system, comprising:
a network;
a managed asset that is coupled to the network and that is operable, in response to detecting an event associated with the managed asset, to send an event notification over the network, wherein the event notification includes each of a description of the event, managed asset identification data that includes a unique identity of the managed asset, and managed asset physical location data that includes the physical location of the managed asset; and
a locator system that is coupled to the network and that is operable to:
receive the event notification;
determine a physical location of the managed asset using the managed asset physical location data; and
display the description of the event, the unique identity of the managed asset, and the physical location of the managed asset.

2. The managed asset physical location identification system of claim 1, wherein the managed asset includes a location storage that stores the managed asset physical location data.

3. The managed asset physical location identification system of claim 1, wherein the managed asset identification data includes unique identity information for the managed asset that is physically affixed to the managed asset and viewable at the physical location of the managed asset.

4. The managed asset physical location identification system of claim 1, wherein the managed asset includes a location determination device that is operable, in response to detecting the event, to determine the managed asset physical location data that is included in the event notification.

5. The managed asset physical location identification system of claim 4,
wherein the location determination device is a Global Positioning System (GPS) device.

6. The system of claim 5, wherein the locator system includes a locator device that is operable to:
retrieve managed asset identification data from the managed asset;
determine managed asset physical location data; and
associate the managed asset identification data and the managed asset physical location data in the managed asset.

7. The managed asset physical location identification system of claim 1, wherein the displaying the description of the event, the unique identity of the managed asset, and the physical location of the managed asset includes displaying a textual description of the event and the unique identity of the managed asset, and displaying a graphical description of the physical location of the managed asset.

8. A networked system, comprising:
a network;
a plurality of managed information handling systems (IHSs) coupled to the network, wherein each of the plurality of IHSs is operable to detect an event associated with that IHS and, in response, send an event notification over the network, wherein the event notification includes each of a description of the event associated with that IHS, IHS identification data that includes a unique identity of that IHS, and IHS physical location data that includes the physical location of that IHS; and
a locator system that is coupled to the network and that is operable to:
receive an event notification from a first IHS of the plurality of IHSs, wherein the event notification includes a description of an event that occurred in the first IHS, first IHS identification data that includes a unique identity of the first IHS, and first IHS physical location data that includes the physical location of the first IHS;
determine a first IHS identification using the first IHS identification data;
determine a physical location of the first IHS using the first IHS physical location data; and
display the description of the event that occurred in the first IHS, the identity of the first IHS, and the physical location of the first IHS.

9. The networked system of claim 8, wherein the first IHS includes a location storage that stores the first IHS physical location data.

10. The networked system of claim 8, wherein the first IHS identification data includes unique identity information for the first IHS that is physically affixed to the first IHS and viewable at the physical location of the first IHS.

11. The networked system of claim 8, wherein the first IHS includes a location determination device that is operable, in response to detecting the event associated with the first IHS, to determine the first IHS physical location data that is included in the event notification.

12. The managed asset physical location identification system of claim 8,
wherein the location determination device is a Global Positioning System (GPS) device.

13. The system of claim 12, wherein the locator system includes a locator device that is operable to:
retrieve an IHS identification from each of the plurality of IHSs;
determine respective IHS physical location data for each of the plurality of IHSs from which the IHS identification was retrieved; and
associate the IHS identification for each IHS with the respective IHS physical location data for that IHS in that IHS.

14. The networked system of claim 8, wherein the displaying the description of the event that occurred in the first IHS, the identity of the first IHS, and the physical location of the first IHS includes displaying a textual description of the event that occurred in the first IHS and the unique identity of the first IHS, and displaying a graphical description of the physical location of the first IHS.

15. A method for providing the physical location of a managed asset, comprising:
receiving an event notification from a managed asset over a network, wherein the event notification includes each of a description of an event associated with the managed asset, managed asset identification data that includes a unique identity of the managed asset, and managed asset physical location data that includes the physical location of the managed asset;
determining a physical location of the managed asset using the managed asset physical location data by a locator system; and
displaying the description of the event, the unique identity of the managed asset, and the physical location of the managed asset on a display.

16. The method of claim 15, wherein the managed asset includes a location storage that stores the managed asset physical location data.

17. The method of claim 15, wherein the managed asset identification data includes unique identity information for the managed asset that is physically affixed to the managed asset and viewable at the physical location of the managed asset.

18. The method of claim 15, wherein the managed asset includes a location determination device that is operable, in response to detecting the event, to determine the managed asset physical location data that is included in the event notification.

19. The method of claim 15, further comprising:
retrieving managed asset identification data from the managed asset;
determining managed asset physical location data; and
associating the managed asset identification data and the managed asset physical location data in the managed asset.

20. The method of claim 15, wherein the displaying the description of the event, the unique identity of the managed asset, and the physical location of the managed asset on the display includes displaying a textual description of the event and the unique identity of the managed asset, and displaying a graphical description of the physical location of the managed asset.
